(19) United States
(12) Patent Application Publication
(10) Pub. No.: US 2003/0136001 A1
(43) Pub. Date: Jul. 24, 2003

(54) Method of producing rotary vane member and rotary vane member

(75) Inventors: Toshihiko Nishiyama, Oyama City (JP); Hiroshi Sugito, Oyama-City (JP); Takahisa Iino, Oyama-City (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/323,704

(22) Filed: Dec. 18, 2002

(30) Foreign Application Priority Data
Dec. 25, 2001 (JP) 2001-392375

(51) Int. Cl. F01D 5/14; B23P 15/04; B21K 25/00

(52) U.S. Cl. 29/889.21; 29/889.7; 416/223 A; 416/241 R; 416/223 B

(57) ABSTRACT

This invention relates to a production method of a moving vane member having high durability and to the moving vane member. An impeller in which tensile residual stress remains is rotated at a rotating speed higher than an operation speed. Then, a high stress portion inside the impeller undergoes plastic deformation due to centrifugal force F. As a result, compressive residual stress remains in the high stress portion after the rotation is stopped, and the tensile residual stress is eliminated. Therefore, repeated tensile stress acting on the high stress portion can be reduced, and an impeller having higher durability can be acquired.

### BACKGROUND OF THE INVENTION

This invention relates to a moving vane member and a production method thereof.

A tensile load is generally applied to a moving vane member due to centrifugal force generated during rotation.

In a turbocharger for supplying compressed air to an internal combustion engine, for example, a rotating speed of an impeller as a moving vane member of the turbocharger on a compressed air side changes in accordance with repetition of operation and stop, or high-speed rotation and low-speed rotation, of the internal combustion engine connected to the turbocharger. Therefore, a tensile repeated load is applied to the impeller during the operation of the internal combustion engine due to the centrifugal force generated by the rotation. Then, tensile fatigue strength generally determines the impeller life.

An exhaust gas re-circulation apparatus (EGR) has increasingly been employed in recent years for internal combustion engines. In consequence, a higher boost pressure has been required and rotating speed ranges of impellers have become broader. Therefore, production of impellers capable of withstanding the use in such a broader range of rotating speed and having higher durability has been desired.

In the production of such impellers, however, a tensile residual stress occurs in most cases inside of the impellers due to their production processes.

Namely, the impellers are mostly produced through casting. During a cooling process of the impellers, the impellers are first cooled from thin part and from their surface side, whereas thick part, particularly their inside, are cooled and hardened later. As a result, the inside of the thick part shrinks and hardens in such a manner as to resist the surface side that has already been hardened, and a pulling force towards the surface side, that is, a tensile stress, remains as a residual stress.

Therefore, the tensile residual stress exists inside the impellers under the state where no load is applied to the impellers, and a higher tensile stress acts on the inside than the rest of portions during the rotation of the impellers. A mean value of the tensile repeated stress is high in the inside of the impellers, fatigue rupture is likely to occur from the inside, and the impellers are thus destroyed.

To cope with this problem, methods of mitigating the tensile residual stress of the inside of the impellers have been proposed in the past.

U.S. Pat. No. 6,164,931 discloses two methods of mitigating the tensile residual stress. One method to impart the compressive residual stress to the surface portion is so-called “shot pinning”. In this method, a large number of shots (small steel balls) are projected and sprayed at a high speed to the surface of an inner diameter portion of an impeller. And the other method is cold processing such as surface rolling.

However, these methods can eliminate only the tensile residual stress of only the limited surface portion, and the tensile residual stress yet remains at the inside spaced apart from the surface of the inner diameter portion. Therefore, impeller life cannot be extended effectively.

It is an object of the invention to provide a production method of a moving vane member having higher durability, and such a moving vane member.

### SUMMARY OF THE INVENTION

The invention provides a method to positively impart a compressed residual stress to a moving vane member to accomplish the object described above.

A production method of a moving vane member according to claim 1 of the invention comprises the steps of producing the moving vane member from a metal material, and rotating the moving vane member at a rotating speed exceeding the operation speed before the moving vane member is actually operated.

When the moving vane member is rotated at a rotating speed exceeding an usual operation speed, a portion of the moving vane member that receives a higher tensile stress, that is, a later-appearing high stress portion, enters a plastic region and plastic deformation takes place. When the rotation is thereafter stopped, the tensile stress acting on the moving vane member due to the centrifugal force is removed. The moving vane member is to shrink at this time and a compressive residual stress occurs inside of the moving vane member. In consequence, the tensile residual stress changes to the compressive residual stress not only on the surface of the portion at which the tensile residual stress occurs but also in the inside of this portion. In this way, the tensile stress occurring in this portion during the operation decreases and a mean value of the repeated stress decreases, too. Therefore, the fatigue strength of the moving vane member can be improved and durability can be improved, too.

Here, the term “actual operation” means the condition where the impeller is assembled into the internal combustion engine, for example, and is used in the practical condition, but does not include performance operation and test operation before the actual use. Therefore, the term “actual operation” in the invention includes the case where the moving vane member is rotated after these performance operation and test operation at a rotating speed exceeding the actual rotating speed, too.

The term “plastic region” means a operating range in which permanent set occurs in the moving vane member, and the term “plastic deformation” means the phenomenon in which the permanent set occurs in the moving vane member and the permanent set itself Therefore, the term “plastic region” in the invention includes also an operating range in which a permanent set corresponding to a stress occurs in the moving vane member when the stress is applied to the member, and a so-called “creep” phenomenon in which a permanent set occurs in the moving vane member irrespective of a stress when the stress is applied to the member and this condition is kept as such for a predetermined time, and the permanent set thereafter increases with the passage of time. The term “plastic deformation” includes also the permanent set that occurs in response to the stress and the permanent set that is generated by the creep phenomenon.

In the production method of the moving vane member described in claim 1, the production method according to claim 2 of the invention has its feature in that the rotating speed is a rotating speed at which the high stress portion of the moving vane member enters the plastic region.

According to this method, the rotating speed is selected so that only the high stress portion of the moving vane member enters the plastic region. Therefore, even when the plastic deformation occurs in this portion, the rest of portions do not undergo plastic deformation but merely undergo elastic deformation, and dimensional accuracy of the moving vane member can be maintained as a whole.

In the production method of the moving vane member according to claim 1 or 2, the production method of claim 3 of the invention has its feature in that a speed holding time for rotating the moving vane member at the rotation speed described above is a time sufficient for the high stress portion of the moving vane member to undergo plastic deformation, but is a time sufficiently shorter than a creep rupture time of the moving vane member.

In the method according to the invention, the plastic deformation includes deformation that occurs in response to the stress applied and deformation that occurs in accordance with the stress application time. In the invention, the high stress portion of the moving vane member has a sufficient time to undergo deformation as to the plastic deformation corresponding to the stress application time. Therefore, a compressive residual stress reliably occurs at this portion.

After a certain time passes, the moving vane member undergoes the creep phenomenon and is finally broken down. In the invention, however, the speed holding time is sufficiently shorter than this rupture time. In consequence, the compressive residual stress can be reliably left and the rupture of the moving vane member does not occur.

In the production method of the moving vane member according to any of claims 1 through 3, the production method according to claim 4 has its feature in that the rotating speed and the speed holding time are set so that a maximum plastic deformation of the high stress portion of the moving vane member attains 0.03 to 0.1%.

This method sets the maximum plastic deformation of the high stress portion to an optimal value. Therefore, influences of the plastic deformation of this portion on dimensional accuracy do not exist and the compressive residual stress can be reliably created. When the maximum plastic deformation of the high stress portion is smaller than 0.03%, it becomes difficult to reliably remove the tensile residual stress and when the maximum plastic deformation is greater than 0.1%, influences on dimensional accuracy are great and the impeller life is likely to be shortened, on the contrary.

In the production method of the moving vane member according to any of claims 1 through 4, the production method according to claim 5 has its feature in that the speed holding time is from 1 to 10 minutes.

According to this method, since the speed holding time is set to an optimal time, workong efficiency becomes high. When the speed holding time is shorter than 1 minute, the rotating speed of the moving vane member must be increased, operation control becomes difficult, and predetermined quality cannot be secured easily. When the speed holding time is longer than 10 minutes, working efficiency gets deteriorated.

A moving vane member according to claim 6 of the invention is produced by the production method of the moving vane member according to any of claims 1 through 5.

In the moving vane member according to the invention, the tensile residual stress is removed and the compressive residual stress is instead added. Therefore, the tensile stress acting on the moving vane member can be reduced during rotation and the mean value of the repeated stress can be mitigated, too. Consequently, the fatigue strength can be improved and durability can be improved, too.

### BRIEF DESCRIPTION OF THE DRAWINGS

FIG. 1 is a sectional view showing a turbocharger according to an embodiment of the invention;

FIG. 2 is a sectional view showing an impeller according to an embodiment of the invention;

FIG. 3 is a sectional view showing a stress distribution of the impeller;

FIG. 4 is a model view showing a concept of plastic deformation of a high stress portion; and

FIG. 5 is a residual stress distribution diagram of the high stress portion before and after execution of process steps of the invention.

### DETAILED DESCRIPTION OF THE PREFERRED EMBODIMENTS

An embodiment of the invention will be explained hereinafter with reference to the accompanying drawings.

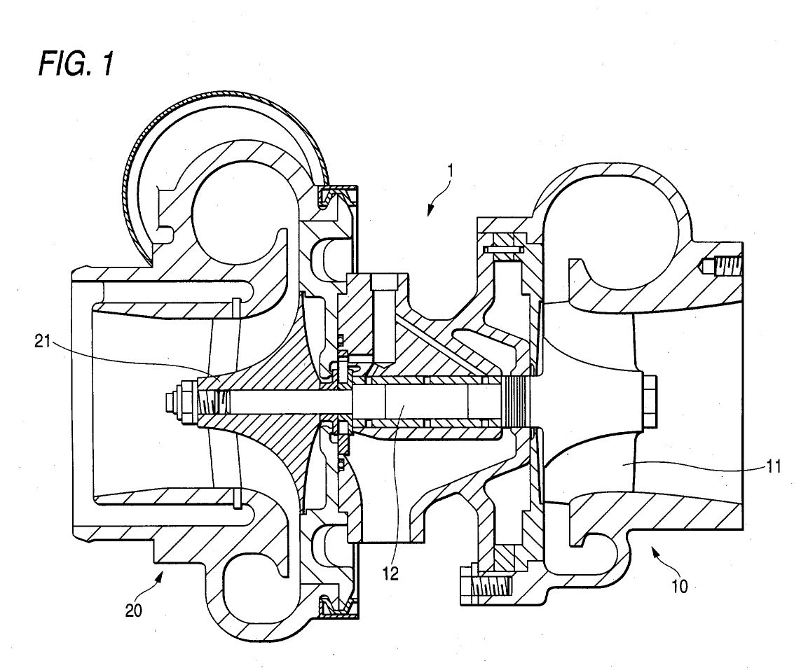

FIG. 1 shows an overall sectional view of a turbocharger.

In the drawing, the turbocharger 1 includes an exhaust turbine 10 connected to an exhaust conduit of an internal combustion engine and a centrifugal compressor 20 connected to an intake of the internal combustion engine.

The exhaust turbine 10 includes therein an exhaust turbine wheel 11. A shaft 12 is integrally formed with the exhaust turbine wheel 11. The compressor 20 includes therein an impeller (moving vane member) 21. A bolt fixes this impeller 21 to the shaft 12.

When exhaust gas is sent from the internal combustion engine to the exhaust turbine 10, exhaust energy turns the exhaust turbine wheel 11 and also the impeller 21 through the shaft 12. Consequently, the air compressed by the compressor 20 is supplied to the internal combustion engine.

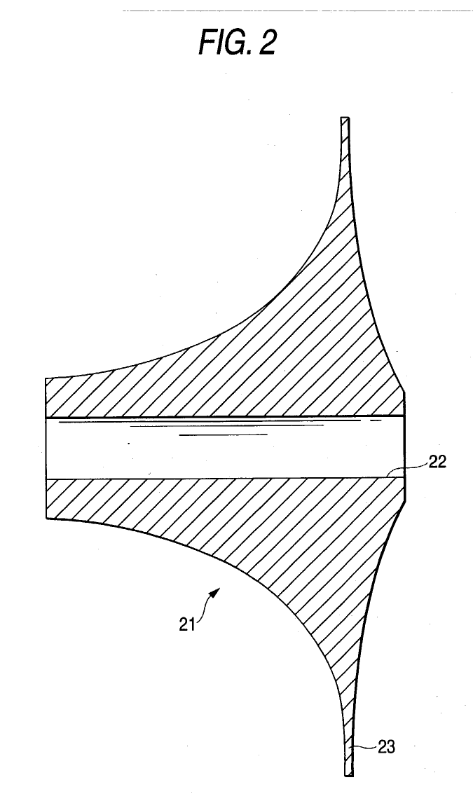

The impeller 21 of the turbocharger 1 having such a construction is formed of a metal material such as titanium, aluminum C355 or aluminum 354 and is generally produced by casting. After shaping by casting, high precision boring is applied to make a mating hole 22 into which the shaft 12 is mated. The impeller 21 is shaped into the shape shown in FIG. 2.

At the time of cooling in its casting process, the impeller 21 is hardened from its thin end part 23 formed on an outer circumferential side. However, thick part of the impeller 21, that is, a portion surrounding the mating hole 22, is hardened later. The surrounding portion of the mating hole 22 is to undergo shrinkage while hardening, but is hardened under the state where a stress that applies pulling force is imparted to the end part 23. In consequence, a tensile residual stress generally exists around the mating hole 22 after casting the impeller 21.

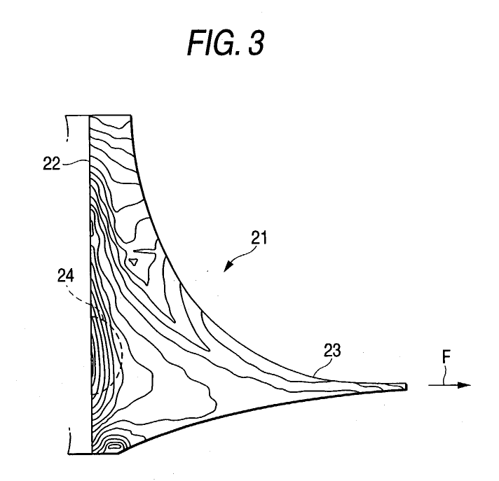

When such an impeller 21 is used for the turbocharger 1, a tensile stress acts on the impeller 21 from the center towards the outer circumferential side due to the centrifugal force F of revolution. As shown in a stress distribution diagram of FIG. 3, a greater tensile stress acts on around the mating hole 22 particularly on the portions corresponding to the end part 23 than the rest of portions. In other words, this portion is a high stress portion 24 (where stress lines are dense).

The internal combustion engine to which the turbocharger 1 is connected repeats operation and stop or high-speed rotation and low-speed rotation, and the impeller 21 assembled into the turbocharger 1 also repeats operation and stop or high-speed rotation and low-speed rotation in accordance with the engine operation. Therefore, the tensile stress repeatedly acts on the impeller 21 during its operation, and the high stress portion 24 receives a repeated tensile stress having a greater mean value of the stress amplitude than the rest of portions. For this reason, when used under the state where the tensile residual stress remains, the impeller 21 is destroyed by fatigue rupture from the high stress portion 24 as explained in “Description of the Related Art”.

Therefore, in this embodiment, the following steps are carried out either before shipment or before actual operation of the impeller 21.

Step 1:

First, the impeller 21 in which the tensile residual stress remains is assembled into the turbocharger 1. The exhaust turbine (10) side is connected to a blower so that air sent from the blower can turn the impeller 21 in place of the exhaust gas of the internal combustion engine.

Step 2:

Subsequently, the air flow rate from the blower is adjusted to turn the impeller 21 at a rotating speed exceeding an actual operation speed for a predetermined time so that the high stress portion 24 undergoes plastic deformation by a predetermined amount.

Here, the rotating speed is set so that the high stress portion 24 enters the plastic region.

The stress (yield stress) at which the high stress portion 24 enters the plastic region is determined by characteristics of the material. Therefore, the rotating speed at which the high stress portion 24 enters the plastic region can be determined when the relation between the rotating speed and the stress distribution of the impeller 21 is in advance measured through experiments.

However, the rotating speed at which the high stress 24 enters the plastic region is not decided to one value but has a certain range of the rotating speed. When the rotating speed is too low such as when it is lower than the lower limit of this rotating speed range, the high stress portion 24 remains within the elastic region with the rest of portions of the impeller 21. When the rotating speed is too high such as when it is higher than the higher limit of this rotating speed range, not only the high stress portion 24 but also the rest of portions of the impeller 21 enter the plastic region.

Therefore, in this embodiment we select the rotating speed from the rotating speed range so that the maximum plastic deformation occurring in the high stress portion 24 is 0.03 to 0.1% and the speed holding time is 1 to 10 minutes.

The maximum plastic deformation is set to 0.03 to 0.1% as described above. When the maximum plastic deformation is smaller than 0.03%, the high stress portion 24 does not sometimes undergo plastic deformation as a whole depending on the characteristics of the material and on the stress distribution condition. When the maximum plastic deformation is greater than 0.1%, on the other hand, dimensional accuracy gets deteriorated and the shaft 12 cannot be mated easily into the mating hole 22, for the high stress portion 24 is at the mating hole 22 of the impeller 21. Furthermore, the impeller life may be shortened, on the contrary.

Incidentally, the maximum plastic deformation in the high stress portion 24 can be determined from the relation between the plastic deformation corresponding to the acting tensile stress and the plastic deformation with the passage of time.

The plastic deformation corresponding to the tensile stress can be acquired by examining the characteristics of the material of the impeller 21, and can be calculated when the tensile stress the high stress portion 24 receives is determined.

The plastic deformation with the passage of time increases with the time in which the impeller 21 receives the tensile stress. If the material 21 continues to receive this tensile stress, the material finally undergoes rupture (creep rupture). The plastic deformation with the passage of time, too, can be calculated by examining the characteristics of the material. The plastic deformation at each time under the stress can be determined when the tensile stress the high stress portion 24 receives can be found out.

On the other hand, the speed holding time is set to 1 to 10 minutes. When the speed holding time is shorter than 1 minute, the rotating speed for securing a necessary plastic deformation must be increased. When the rotating speed is increased more than necessary, however, the progress of the plastic deformation with the passage of time becomes faster, too, and great influences are exerted on the plastic deformation due to variance of the speed holding time. In other words, slight variance or an error of the speed holding time of the impeller 21 invites a large change of the plastic deformation, and the production of impellers 21 having predetermined quality becomes difficult.

When the speed holding time is longer than 10 minutes, the production time for producing one impeller 21 gets elongated and production efficiency drops.

Step 3:

After the lapse of the speed holding time, the rotation is stopped. In other words, after rotating at the rotating speed and for the certain time selected in advance in Step 2 is kept, the rotation is stopped.

In the impeller 21 passed through the process steps described above, 0.3 to 0.1% of maximum plastic deformation occurs in the high stress portion 24. The tensile residual stress exists from the beginning to a certain extent in portions other than the high stress portion 24 around the mating hole 22. Because the outer diameter is small, however, the resulting centrifugal force is small, too. For this reason, the portions other than the high stress portion 24 do not fall off from the elastic region even when the tensile stress due to the centrifugal force acts upon them. These portions return to the original shape when the tensile stress is released with the stop of the rotation.

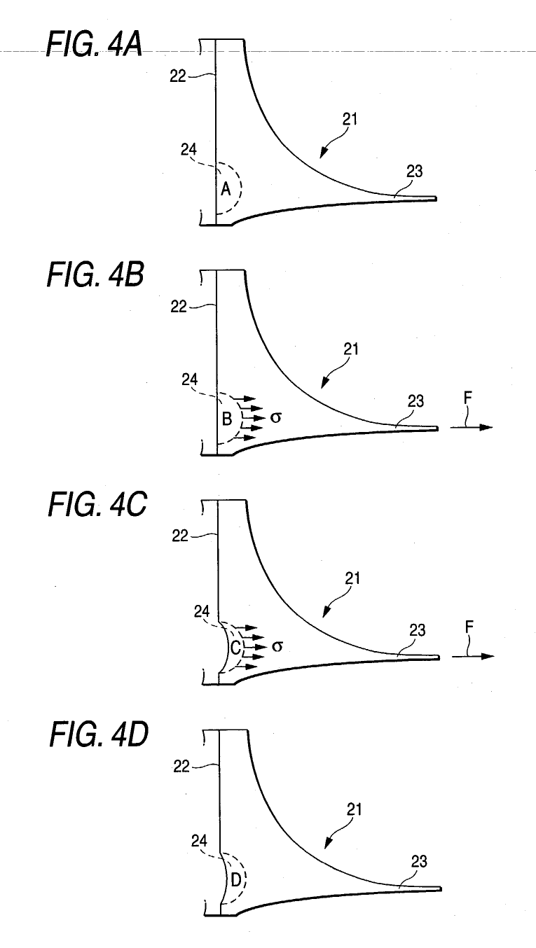

Next, the stress state inside the impeller 21 in the production method of the impeller 21 described above will be explained with reference to the drawings. FIG. 4 is a model view showing a concept of the plastic deformation of the high stress portion 24. The stress change explained hereby simplifies the change occurring in practice for the sake of explanation.

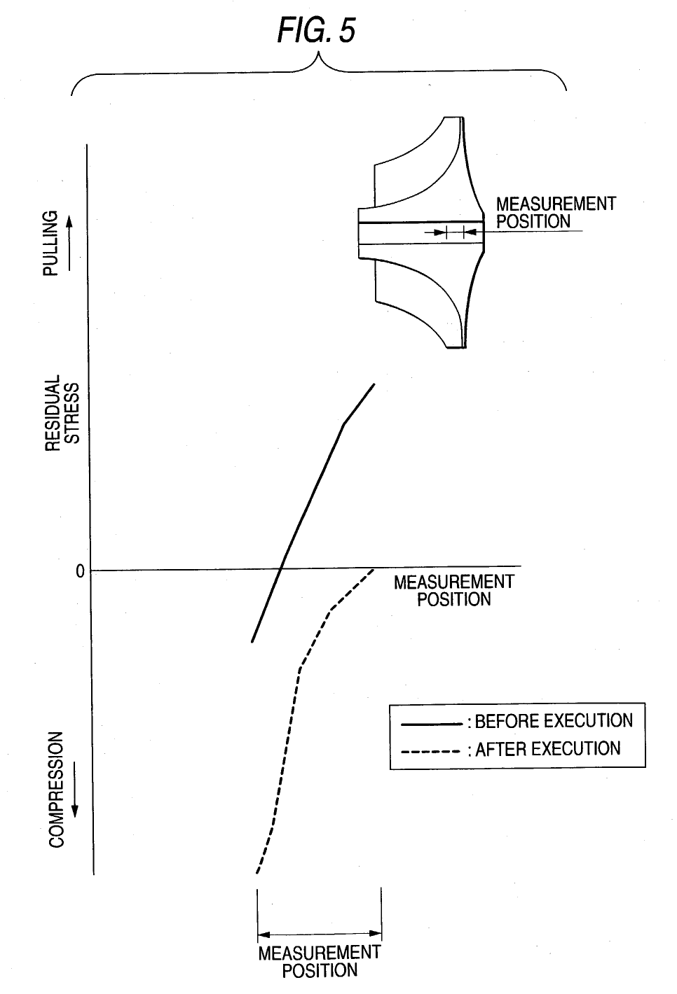

Referring to FIG. 4A, a tensile residual stress A generated during the casting process exists in the high stress portion 24 under the state before the rotation of the impeller 21. It can be appreciated from FIG. 5, too, that the tensile residual stress exists in the proximity of the high stress portion 24 as a whole.

In FIG. 4B, when the impeller 21 starts rotating, the tensile stress σ acts on the high stress portion 24 from the center to the outer circumferetial side due to the centrifugal force F generated by the rotation. As a result, a greater tensile stress B (B ≈A+σ) acts on the high stress portion 24 than the rest of portions, and the high stress portion 24 enters the plastic region. The tensile residual stress exists to a certain extent to the rest of portions other than the high stress portion 24 around the mating hole 22. However, because the centrifugal force generated during the rotation is small (because the outer diameter is small and the peripheral speed is low), the tensile stress acting on these portions is small, too. Therefore, the portions other than the high stress portion 24 neither fall off from the elastic region nor undergo deformation even when the impeller 21 is rotated, but keep equilibrium under the state where they extend toward the outer circumference side.

In FIG. 4C, the high stress portion 24 that enters the plastic region undergoes the plastic deformation in accordance with the stress. When the rotation is held under this state, the plastic deformation proceeds in accordance with the time. In this instance, the high stress portion 24 generates stress mitigation due to the plastic deformation with the result that the stress of the high stress portion 24 drops to C (B>C).

In FIG. 4D, by the time the rotation is stopped, the high stress portion 24 has already undergone the plastic deformation, and the inner diameter has become greater by 0.03 to 0.1%. The rest of portions have only undergone the elastic deformation and return to the dimension before the rotation when the rotation is stopped. The stress in the high stress portion 24 changes to C due to stress mitigation during the plastic deformation. However, when the rotation is stopped, the tensile stress σ is removed, and the stress changes to C−σ≈D. Since the surrounding portion of the mating hole 22 that has undergone elastic deformation tries to return towards the mating hole 22 with respect to the high stress portion 24 that has undergone the plastic deformation towards the outer circumferential side, the high stress portion 24 is pushed from the surrounding portions. Therefore, the stress the high stress portion 24 receives is the compressive stress, and the compressive residual stress occurs at this portion 24.

It can be appreciated from FIG. 5 in connection with the residual stress in the high stress portion 24 of the impeller 21 produced by the production steps described above that the tensile residual stress acting on this portion 24 has changed to the compressive residual stress comparing to before execution of process steps.

This embodiment provides the following effects.

(1) Because the impeller 21 is rotated at a higher rotating speed than the actual operation speed, the high stress portion 24 undergoes plastic deformation and consequently, the compressive residual stress occurs in this portion 24. When such an impeller 21 is employed, the mean value of the repeated stress applied to this portion 24 at the time of the operation and the stop of the impeller 21 can be reduced. In consequence, the fatigue strength of the impeller 21, that is, durability, can be improved. Although titanium has been used in the past in the production of the impeller 21 so as to secure durability, the method of this embodiment can sufficiently secure durability of an equal or higher level than that of the prior art by use of aluminum C355 or aluminum 354, and can produce the impeller more economically.

(2) The rotating speed is selected so that only the high stress portion 24 undergoes plastic deformation. Therefore, even when the high stress portion 24 as a part of the mating hole 22 of the impeller 21 undergoes plastic deformation, most of the other portions merely undergo elastic deformation and can keep the dimension before rotation. In other words, the influences on dimensional accuracy can be eliminated and the mating state with the shaft 12 can be kept under a satisfactory state.

(3) The rotating speed and the speed holding time are selected so that the maximum plastic deformation of the high stress portion 24 attains 0.03 to 0.1%. Therefore, the compressive residual stress can be reliably created and no adverse influences are exerted on dimensional accuracy of the mating hole 22.

(4) The rotating speed is selected so that the speed holding time is from 1 to 10 minutes. Therefore, variance of quality resulting from variance of the speed holding time does not occur and impellers 21 having predetermined quality can be produced. Since the processing time of one impeller 21 is not much long, production efficiency is high.

The invention is not limited to the embodiments described above, and any modifications and improvements that could be attained within the range capable of accomplishing the objects of the invention are naturally embraced in the scope of the invention.

For example, the exhaust turbine wheel 11 of the turbocharger 1 is caused to rotate by the air pressure from the blower in the embodiment described above, it may be rotated by a discrete motor without assembling the impeller 21 into the turbocharger 1.

The supercharger having the impeller 21 is not limited to the turbocharger 1 but may be a mechanically driven supercharger.

The moving vane member is not limited to the impeller used for the supercharger but may be a fan or a blower each of which has vanes and rotates, and need not always has the mating hole of the embodiment. The shape of the moving vane members is not limited to the centrifugal type, but may be of an axial flow type or a mixed flow type.

What is claimed is:

1. A method of producing a moving vane member comprising the steps of:
producing said moving vane member from a metal material; and
rotating said moving vane member at a rotating speed exceeding an operation speed before said moving vane member is actually operated.

2. A method of producing a moving vane member according to claim 1, wherein said rotating speed is a rotating speed at which a high stress portion of said moving vane member enters a plastic region.

3. A method of producing a moving vane member according to claim 1 or 2, wherein a speed holding time for rotating said moving vane member at said rotation speed is a time sufficient for said high stress portion of said moving vane member to undergo plastic deformation but is a time sufficiently shorter than a creep rupture time of said moving vane member.

4. A method of producing a moving vane member according to any of claims 1 through 3, wherein said rotating speed and said speed holding time are set so that a maximum plastic deformation of said high stress portion of said moving vane member attains 0.03 to 0.1%.

5. A method of producing a moving vane member according to any of claims 1 through 4, wherein said speed holding time is from 1 to 10 minutes.

6. A moving vane member produced by said production method of a moving vane member according to any of claims 1 through 5.
